(19) United States
(12) Patent Application Publication
(10) Pub. No.: US 2006/0135189 A1
(43) Pub. Date: Jun. 22, 2006

(54) Method of controlling a received signal strength target in a wireless communication system

(76) Inventors: Shirish Nagaraj, Randolph, NJ (US); Anil M. Rao, Cedar Knolls, NJ (US)

Correspondence Address: HARNESS, DICKEY & PIERCE, P.L.C., P.O. BOX 8910, RESTON, VA, 20195, US

(21) Appl. No.: 11/017,924

(22) Filed: Dec. 22, 2004

(51) Int. Cl. H04B 7/00; H04Q 7/20

(52) U.S. Cl. 455/513

(57) ABSTRACT

In the method of controlling a received signal strength target in a wireless communication system, the received signal strength target is adjusted based on a service outage metric.

### BACKGROUND OF THE INVENTION

1. Field of the Invention

The present invention relates to wireless communication; and more particularly, controlling a received signal strength target in a wireless communication system.

2. Description of Related Art

The need for high speed packet data services in the reverse link has motivated new standards development in both UMTS and cdma2000 wireless systems. In UMTS the high speed reverse link or uplink is referred to as EUDCH (enhanced uplink dedicated channel) or HSUPA (high speed uplink packet access) and standards work is ongoing in Release 6. In cdma2000 the high speed reverse link is present in Rev. A (1×EV-DO) and Rev. D (1×EV-DV). One purpose of a high speed reverse link channel specification is to improve the throughput and coverage as well as reduce delay. This is achieved by introducing a new medium access control (MAC) functionality in the base station (in cdma2000) or node B (in UMTS), which is capable of fast resource allocation to users in the cell.

A quantity known as RoT (rise over thermal) is an important parameter in the reverse link. The RoT dictates both the achievable throughput as well as cell coverage for user terminals which have limited power resources. Numerous well-known methods exist for measuring or determining the RoT, which is a total received power normalized by the noise floor.

The new MAC entity at the base station maximizes throughput by filling the available RoT every scheduling interval (e.g., transmission time interval). The RoT at the base station consists of three main components as shown in FIG. 1. Without loss of generality, the acronyms from UMTS for the three contributions to the RoT are shown. The three main components of RoT are:
1. Interference from users not connected to the cell of interest (Ioc).
2. Received power from users connected to the cell of interest which are not capable of utilizing the new high speed reverse link functionality; namely, uplink dedicated channel (DCH) users. DCH users may be either simple voice users whose rates are not controlled (except at the application level such as with the adaptive multirate codec) or data users whose rates are controlled in the radio network controller (RNC) at a very slow rate such that they cannot take advantage of rapidly changing interference conditions at the base station.
3. High speed reverse link capable users (E-DCH).

The new MAC entity in UMTS is referred to as the MAC-e. Through proper resource allocation the MAC-e is capable of controlling the E-DCH contribution to the RoT. The total RoT is regulated in such a way so as to not adversely affect the coverage for legacy DCH users. Cellular operators typically plan the average RoT for a cell to achieve a certain capacity and coverage using a link budget. Higher RoTs achieve higher capacity but at the cost of coverage since user terminals have a maximum power constraint. To ensure adequate coverage for users at the cell edge and prevent dropped calls, the total RoT is controlled by applying a blocking threshold. That is, when the measured RoT exceeds the RoT blocking threshold, new users are blocked from entering the system and prevented from causing further increases in the RoT. It is desired to operate a system with a low probability of blocking, typically on the order of 2%. That is, the probability that the measured RoT exceeds the RoT blocking threshold is 2%.

The MAC-e allocates rates every TTI (transmission time interval), where the TTI length for E-DCH can be either 2 ms or 10 ms. The MAC-e allocates rates in a variety of fashions for the E-DCH users. To ensure the same coverage for DCH users, the MAC-e allocates rates to E-DCH users in such a fashion that when the E-DCH contribution to the RoT is added to the DCH and Ioc portions of the RoT, the total RoT does not exceed the blocking threshold at the operator's prescribed rate (2% for example). There can be significant variability in the total RoT between the times the MAC-e allocates rates due to events in other cells (Ioc contribution to RoT) or due to the imperfect power control of users in the cell of interest (both DCH and E-DCH). In addition, there are measurement inaccuracies in the RoT which may cause a specific rate allocation scheme to in fact exceed its intended RoT. For these reasons, as shown in FIG. 1, an RoT target is used in the MAC-e, and the MAC-e allocates E-DCH users such that the RoT target is reached. The RoT target is set to some fixed level below the RoT blocking threshold (see FIG. 1). This leaves a margin for the total RoT to vary in between scheduling intervals.

If the RoT target is too large (i.e., margin is too small) then, while the E-DCH can allocate higher rates since it has a larger amount of RoT to work with, the total RoT will exceed the RoT blocking threshold too often and cause a larger than desired call blocking in the system. If the RoT target is too small, then while the rate of blocked calls will be better than the desired rate, the throughput of the E-DCH users will be reduced since the MAC-e would have had to allocate lower rates. Known methods involve setting a fixed target RoT. For example, the RoT target may be set for a worst case scenario. In this instance, the blocking threshold is generally not exceeded by more than the desired percentage (e.g., 2%). However, the throughput of the E-DCH users can be quite poor. As another example, the RoT target is set to an average value. In this situation, as traffic distributions change, a larger than desired call blocking may occur or the throughput of the E-DCH users may be poor.

### SUMMARY OF THE INVENTION

The present invention provides a method of controlling a received signal strength target in a wireless communication system.

In one embodiment, the received signal strength target is adjusted based on a service outage metric.

For example, the service outage metric may be whether new users are being blocked from entering the wireless communication system, may be a probability of a new user being denied access to the wireless communication system, may be a probability that an existing user is dropped from the wireless communication system, may be a rate at which existing users are being dropped from the wireless communication system, may be cell wide quality of service metric, or etc.

In one embodiment, the adjusting step decreases the received signal strength target when the service outage metric indicates an undesirable level of service outage.

In another embodiment, the adjusting step increases the received signal strength target when the service metric does not indicate an undesirable level of service outage.

In yet another embodiment, the method includes allocating E-DCH users such that the total received signal strength, which includes the Ioc, DCH and E-DCH contributions, tracks the adjusted received signal strength target.

The received signal strength target may be a received signal strength indicator measurement target, a rise-over-thermal target, or etc.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a prior art method of setting a RoT (rise-over-thermal) target and allocation of E-DCH users;

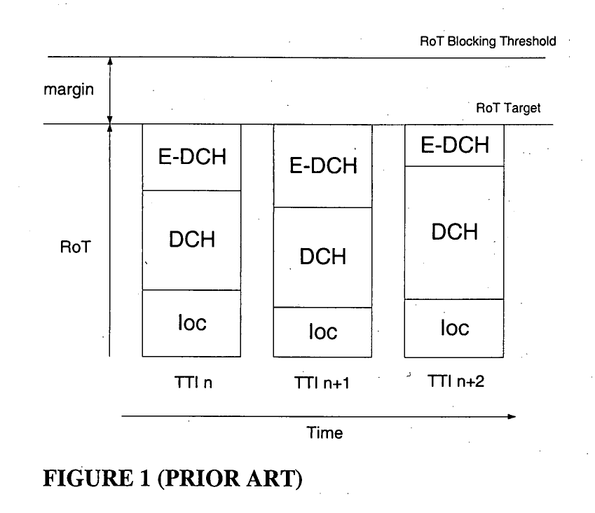

FIG. 2 illustrates a flowchart for an embodiment of the method of controlling a received signal strength target according to the present invention;

FIG. 3 illustrates the effects of the method according to the present invention on the RSS target and the allocation of E-DCH users;

FIG. 4 illustrates a graph of the number of users per cell versus an RoT outage probability;

FIG. 5 illustrates a graph of the number of users per cell versus cell throughput; and

FIG. 6 illustrates a graph of the number of users per cell versus an average RoT.

### DETAILED DESCRIPTION OF THE EMBODIMENTS

A reality of wireless communication systems is that traffic distributions, especially with high speed packet data users throughout the system, do not remain constant but change with time. The methodology of the present invention provides a receive signal strength target which is adapted to the traffic distribution as it changes over time. As will be appreciated, rise-over-thermal (RoT) is but one metric for indicating a received signal strength. For example, the well-known received signal strength indicator (RSSI) measurement is another metric indicating received signal strength. Accordingly, the terminology received signal strength should be construed to cover any metric, whether an amplitude (e.g., in decibels), a power (e.g., in Watts), etc., that provides an indication of received signal strength (RSS).

Furthermore, the inventors contemplate the use of any of a number of service outage metrics instead of just a blocking threshold in their methodology. For example, other service outage metric may be:
The blocking of users discussed previously with respect to the setting of a blocking threshold.
A blocking probability, which is the probability that a new user is denied access to the wireless communication system because of, for example, too high an RoT.
A dropping probability, which is the probability that an existing user is dropped from the wireless communication system because the user cannot sustain the connection due to, for example, excessively high RoT.
A dropping rate, which is the rate at which users are being dropped from the wireless communication system.
A Cell-wide QoS, which is a metric that indicates the perceived quality of service over all users in the cell. For example, large RoTs may lead to periodic power clipping of the mobile terminal causing poor quality of service. A cell-wide metric could be the fraction of time some fraction of users are transmit power clipping or the fraction of time that some fraction of users have packets received in error.
   As will be appreciated, this list of possible service outage metrics is by no means exhaustive.

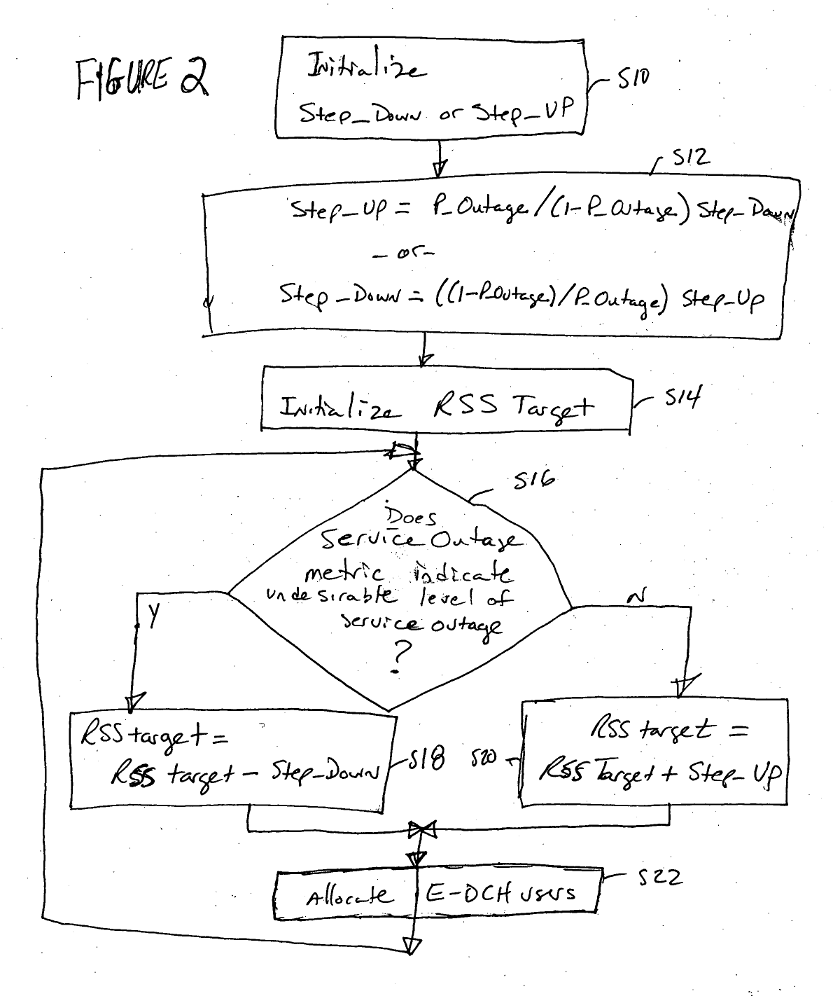

Next, an example embodiment of the method for controlling a received signal strength (RSS) target according to the present invention will be described with respect to the flow chart illustrated in FIG. 2. For the purposes of description, the method of FIG. 2 will be described as implemented at a node B. However, it will be understood that this method may be implemented at other entities of the wireless communication system such as a radio network controller (RNC). Also while the terminology of the UTMS standard is used in the description of FIG. 2, as stated previously, the present invention is not limited to this standard in its application.

As shown in FIG. 2, in step S10 the node B initializes one of the two adjustment values Step_Up and Step_Down. The initialization value may be a design parameter set by the system designer. For example, the Step_Down adjustment value may be initialized to 0.5 dB or the Step_Up adjustment value may be initialized to 0.125 dB. Then, in step S12, the node B may determine the other of the Step_Down and Step_Up adjustment values according to the following expressions:
Step_Up (dB)=(P_Outage/(1−P_Outage)) Step_Down (dB)
Step_Down (dB)=((1−P_Outage)/(P_Outage)) Step_Up (dB)
where P_Outage is the desired limit on the probability of a system outage event (e.g., blocked calls, dropped calls, poor QoS, etc.). P_Outage may be a design parameter set by the system designer. For example, P_Outage may be 2%.
Alternatively, the other of the two adjustment values may be initialized as well. Next, the node B initializes the RSS target in step S14. The initialization value may be a design parameter set by the system designer. For example, the initialization value for the RSS target may be 3.9 dB.

In step S16, the node B determines whether a service outage metric indicates an undesirable level of service outage. As discussed above, many service outage metrics exist, so it is possible to implement this step in many ways. For example, if the service outage metric is the blocking of users, then in step S16 a measured RoT greater than a blocking threshold would indicate an undesirable level of service outage. However, if the service outage metric is dropping probability or blocking probability, the current dropping or blocking probability is determined in the well-known fashion. Then, in step S16 if this determined probability exceeds a threshold probability, set as a design parameter, the node B determines that this indicates an undesirable level of service outage. If the service outage metric is the dropping rate, then the current dropping rate is determined in any well-known manner. Then in step S16, if the current dropping rate exceeds a threshold rate, set as a design parameter, the node B determines that this indicates an undesirable level of service outage. Similarly, if the service outage metric were a cell-wide QoS such as users are transmit power clipping, then the percentage of users transmit power clipping is determined in any the well-known fashion. Then, in step S16, if this determined percentage exceeds a threshold, set as a design parameter, the node B determines that this indicates an undesirable level of service outage.

When the node B determines that an undesirable level of service outage exists, then in step S18, the node B adjusts the RSS target according to the following expression:
RSS target=RSS target−Step_Down.

Alternatively, when the node B does not determine an undesirable level of service outage exists, then in step S20, the node B adjusts the RSS target according to the following expression:
RSS target=RSS target+Step_Up.
As shown in FIG. 2, once the RSS target is established, the E-DCH users may be allocated up to the RSS target in Step S22. Processing then returns to Step S16. In one embodiment of the present invention, the RSS target is adjusted each transmission time interval (TTI). Also, the service outage metric over a TTI is used to adjust the RSS target. However, a sliding window of more than one TTI may be used for determining the service outage metric.

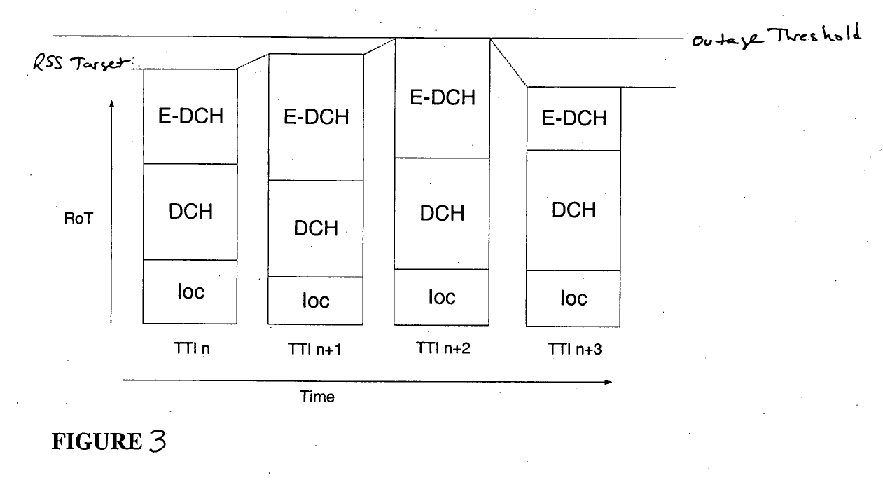

The effects of this methodology on the RSS target and the allocation of E-DCH users are illustrated in FIG. 3. As shown, the RSS target varies over time. This permits a more optimal scheduling of E-DCH users.

A simulation was conducted to study the effectiveness of the methodology according to the present invention. Table 1 below summarizes the simulation assumptions made.

TABLE 1
Simulation assumptions.

| | |
|---|---|
| TTI length | 10 ms |
| Measured_RoT | TTI averaged RoT |
| Service Outage Metric is Blocking | 7 dB threshold |
| of Users and a | |
| RoT_Outage_Threshold (i.e., | |
| blocking threshold) is used. | |
| P_Outage | 2% |
| Step_Down | 0.5 dB |
| Initial RoT_Target | 1.0 dB |
| Cell Layout | Isolated cell with 30% loading |
| | assumed for Ioc |
| Cell radius | 667 m |
| User mobility | Random Walk |
| DCH users | None |
| E-DCH user traffic | Full Buffer |
| E-DCH user rate set | 0 kbps up to 2016 kbps |

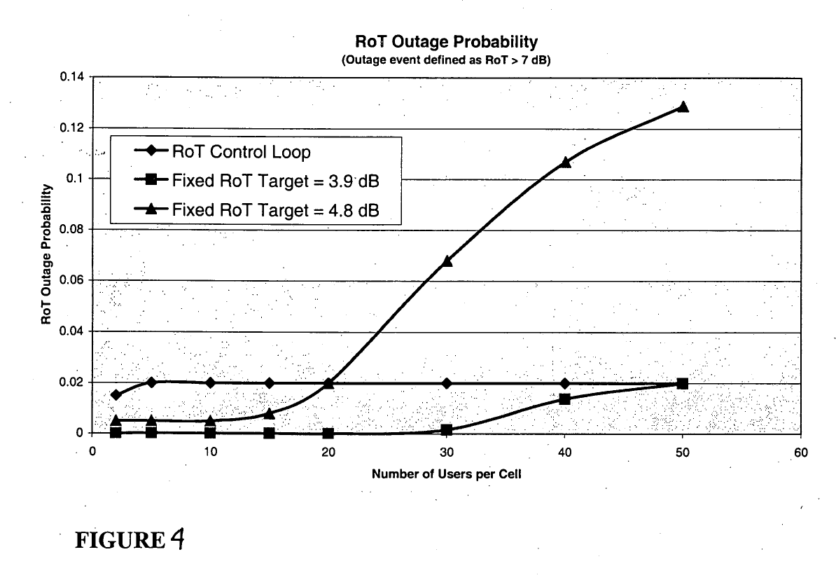

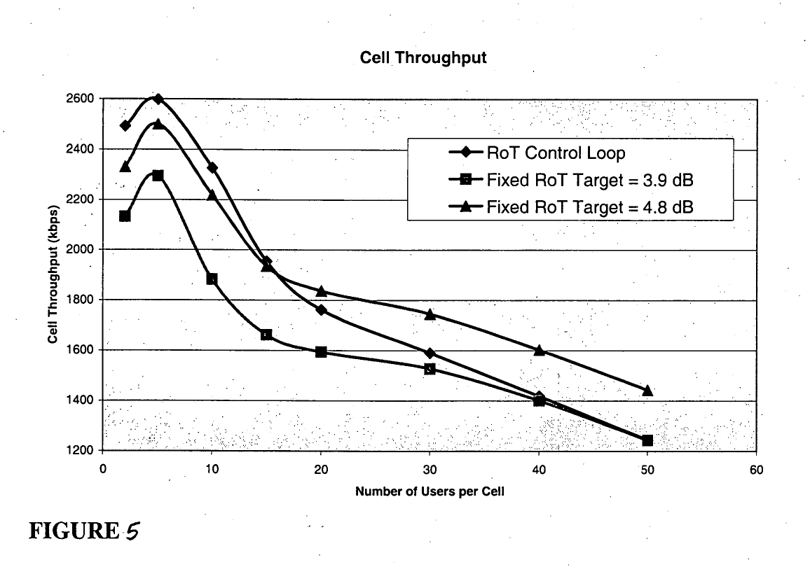

In this simulation we consider an RoT Outage Threshold of 7 dB and P_Outage of 2%. This is a commonly used set of assumptions. The offered load was varied by varying the number of users in the cell from 2 users to 50 users. If the load was to vary as such and the RoT_Target were fixed, a cellular operator would need to set the RoT_Target based on the worst traffic distribution. In this case that occurs for 50 users per cell. The optimum fixed RoT_Target for 50 users per cell is RoT_Target=3.9 dB for a blocking probability of 2%. From FIG. 4 it is evident that such a selection for the RoT_Target achieves a 2% blocking probability for 50 users per cell. However if the offered load is smaller, the blocking probability becomes much smaller than 2%. The price that must be paid is seen in FIG. 5 for the cell throughput of the E-DCH users, where the fixed RoT_Target designed for an offered load of 50 users underperforms the method of the present invention by as much as 20%.

If the operator were to choose a fixed RoT_Target designed for an average offered load of 20 users per cell, the optimum fixed RoT target is 4.8 dB. In this case from FIG. 4 we can see that while for 20 users per cell the blocking probability is the desired 2%, if the offered load were to increase then there would be a high number of blocked calls in the system. In addition, for a smaller offered load although the blocking probability is better than desired, there is a price to pay in throughput as seen in FIG. 5.

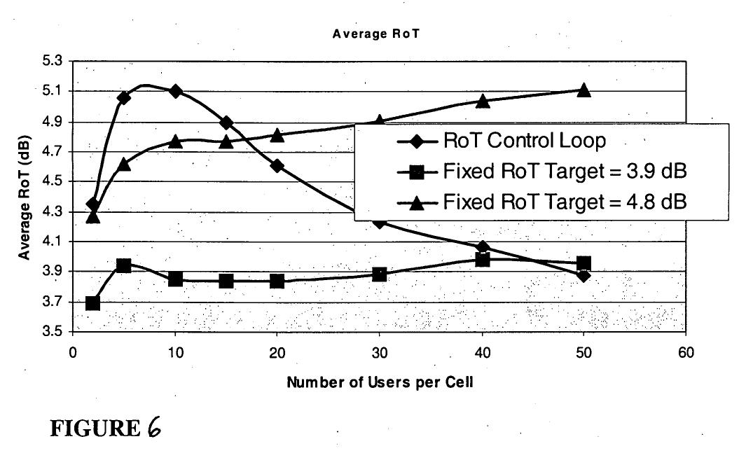

In this simulation of the method according to the present invention, the RoT target is adaptively changed depending on the traffic characteristics to maintain a steady blocking probability as shown in FIG. 4. Namely, with respect to step S16 of FIG. 2, the average RoT over the TTI is compared to the blocking threshold to determine if an undesirable level of service exists. Therefore the method of the present invention is able to maximize throughput with the constraint on the blocking probability. Note from FIGS. 5 and 6 that the methodology reduces the RoT target significantly as the offered load changes in order to maintain the blocking probability constraint. Hence the method of the present invention offers significant advantages over a fixed RoT Target methodology.

Furthermore, it will be readily apparent from the forgoing disclosure that various changes and modification may be made to the methodology described above. Such variations are not to be regarded as a departure from the invention, and all such modifications are intended to be included within the scope of the invention.

I claim:

1. A method of controlling a received signal strength target in a wireless communication system, comprising:
adjusting the received signal strength target based on a service outage metric.

2. The method of claim 1, wherein the service outage metric is whether new users are being blocked from entering the wireless communication system.

3. The method of claim 1, wherein the service outage metric is a probability of a new user being denied access to the wireless communication system.

4. The method of claim 1, wherein the service outage metric is a probability that an existing user is dropped from the wireless communication system.

5. The method of claim 1, wherein the service outage metric is a rate at which existing users are being dropped from the wireless communication system.

6. The method of claim 1, wherein the service quality metric is a cell wide quality of service metric.

7. The method of claim 1, wherein the adjusting step decreases the received signal strength target when the service outage metric indicates an undesirable level of service outage.

8. The method of claim 7, wherein when the adjusting step decreases the received signal strength target, the received signal strength target is decreased by a decrement amount.

9. The method of claim 7, wherein the adjusting step increases the received signal strength target when the service metric does not indicate an undesirable level of service outage.

10. The method of claim 9, wherein the adjusting step decreases the received signal strength target by a decrement amount when decreasing the received signal strength target, and increases the received signal strength by an increment amount when increasing the received signal strength target.

11. The method of claim 10, wherein the increment amount=(p/(1−p))*(the decrement amount), where p is a selected probability of the service outage metric reaching an undesirable level.

12. The method of claim 1, wherein the adjusting step increases the received signal strength target when the service outage metric does not indicates an undesirable level of service outage.

13. The method of claim 1, wherein the adjusting step compares the service outage metric to a service outage threshold, and changes the received signal strength target based on a result of the comparison.

14. The method of claim 1, wherein the adjusting step adjusts the received signal strength target based on the service outage metric for a period of time.

15. The method of claim 14, wherein the period of time is a transmission time interval.

16. The method of claim 1, further comprising:
allocating EDCH users such that the received signal strength tracks the adjusted received signal strength target.

17. The method of claim 16, wherein the adjusting and allocating steps are performed each transition time interval.

18. The method of claim 1, wherein the wireless communication system is one of a UMTS and cdma2000 system.

19. The method of claim 1, wherein the received signal strength target is a received signal strength indicator measurement target.

20. The method of claim 1, wherein the received signal strength target is a rise-over-thermal target.
